(19) United States
(12) Patent Application Publication
(10) Pub. No.: US 2014/0241445 A1
(43) Pub. Date: Aug. 28, 2014

(54) Method for providing quality of service in a multiuser orthogonal frequency division multiplex (OFDM) system

(71) Applicant: Univerza v Ljubljani, Fakulteta za elektrotehniko, (US)

(72) Inventors: Miha Rugelj, Trebnje (SI); Urban Sedlar, Bohinjska Bistrica (SI); Janez Sterle, Ljubljana (SI); Mojca Volk, Bled (SI); Janez Bester, Zgornja Besnica (SI); Andrej Kos, Ribnica (SI)

(73) Assignee: UNIVERZA V LJUBLJANI, FAKULTETA ZA ELEKTROTEHNIKO, Ljubljana (SI)

(21) Appl. No.: 13/779,976

(22) Filed: Feb. 28, 2013

(51) Int. Cl. H04W 72/08

(52) U.S. Cl. CPC H04W 72/082
USPC 375/260

(57) ABSTRACT

A method that provides quality of service in a multiuser orthogonal frequency division multiplex system. The method assures quality of service at application level, which directly affects user's satisfaction with the service for interactive applications, such as web browsing, and real-time applications. The method uses advanced dynamic resource allocation to achieve a common subjective user state and/or dynamic resource allocation to optimize the throughput of the system while increasing the quality of service at application level. The method takes advantages of the information of the instantaneous channel gain and information of the objective technical parameters of the system and applications. With the incorporation of the technical parameters of the system and applications into the subcarrier allocation, the method may provide quality of service at application level, allow explicit control of system resources, ensure fairness in resource allocation and achieve the optimal throughput of the multiuser orthogonal frequency division multiplex system.

### BACKGROUND

1. Field of the Invention

The present invention relates to a method that provides quality of service (QoS) at application level in a multiuser orthogonal frequency division multiplex (OFDM) system, wherein quality of service is provided with advanced dynamic resource allocation.

2. Description of the Related Art

Nowadays users expect high data rates, high availability and appropriate quality of service in wireless and mobile communication systems under adverse conditions such as hostile mobile environments, intersymbol interference, limited available spectrum and radio propagation anomalies. Recent known systems provide quality of service at the network level, which does not include the entire end-to-end communication chain or take into account users' satisfaction with the service, perception of quality and previous experience with the system. Assuring quality of service at application level is therefore important factor because it directly affects users' satisfaction with the service.

Recently, research has been carried out on algorithms for subcarrier and power allocation in multiuser OFDM systems. Said algorithms can be categorized into two general types: static and dynamic resource allocation. The systems using dynamic resource allocation consider information of instantaneous channel gain on communication channel with associated algorithms solving complex systems of equations with the nonlinear optimization problem. Some recent algorithms also provide fairness to the process of resource allocation. Fairness is typically incorporated into the system by using different utility functions, adaptive subcarrier allocation with proportional constraints or by assigning different priorities to individual users. Providing said priorities and achieving relevant quality of service at application level are still unresolved issues.

### BRIEF SUMMARY

In one aspect, the method may provide an optimal quality of service at application level and optimal throughput of the wireless and mobile multiuser OFDM systems by using advanced dynamic resource allocation on the transmit unit of the system.

This effect may be achieved with the characteristics disclosed in the first claim. The method provides an appropriate QoS at application level for all users of the wireless environment while optimizing the throughput of the OFDM system by using advanced dynamic subcarrier allocation. QoS at application level is provided for interactive and real-time applications.

### BRIEF DESCRIPTION OF THE SEVERAL VIEWS OF THE DRAWINGS

These and other features are described in more detail in the following description, given by the way of example and with the accompanying drawings, where

FIG. 1 shows a block diagram of the multiuser OFDM system with dynamic subcarrier and power allocation,

FIG. 2 shows a flow diagram of the method, which determines the user's required capacities to achieve individual subjective states,

FIG. 3 shows a flow diagram of the method that uses dynamic subcarrier allocation to achieve a common subjective user state, and

FIG. 4 is a flow diagram of the method that uses dynamic subcarrier allocation to optimize the throughput of the OFDM system while increasing the QoS at application level.

### DETAILED DESCRIPTION

The method described herein relates to wireless networks, such as a local wireless network and mobile networks, using multiuser OFDM system. As used hereinafter, the term “transmit unit” includes but is not limited to a base station or other similar devices capable of transmitting signals in wireless environment. The term “receive unit” includes but is not limited to a mobile station, user equipment or other similar devices capable of receiving signals in wireless environment. In addition, the term “base station” includes but is not limited to an eNode B in LTE technology, access points or other interfacing devices capable of transmitting signals. The term “user” includes user equipment capable of receiving signals in wireless environment. The present disclosure assumes that the information of instantaneous channel gain on each subcarrier is available to the transmit unit, and therefore the transmit unit can utilize the information to determine the assignment of subcarriers to users. Furthermore, the disclosure also assumes that the transmit unit has available information of the technical parameters of the system and applications, such as the web page size, round trip time, packet loss, etc., and information of previous subjective users' states (i.e. previous users' satisfaction with the service), such as previous MOS (Mean opinion score) states. The MOS methodology provides a connection between the objective technical parameters of the system and applications, such as delay, throughput, jitter, packets loss, web page size in case of web browsing, and subjective user states which represent user satisfaction with the service or QoS at application level. Typically, the five point MOS scale (states 1, 2, 3, 4 and 5) is used, which is also proposed in the present invention, although the invention is not limited to only five point MOS scale, but also allows using other subjective scales that represent user satisfaction or QoS at application level.

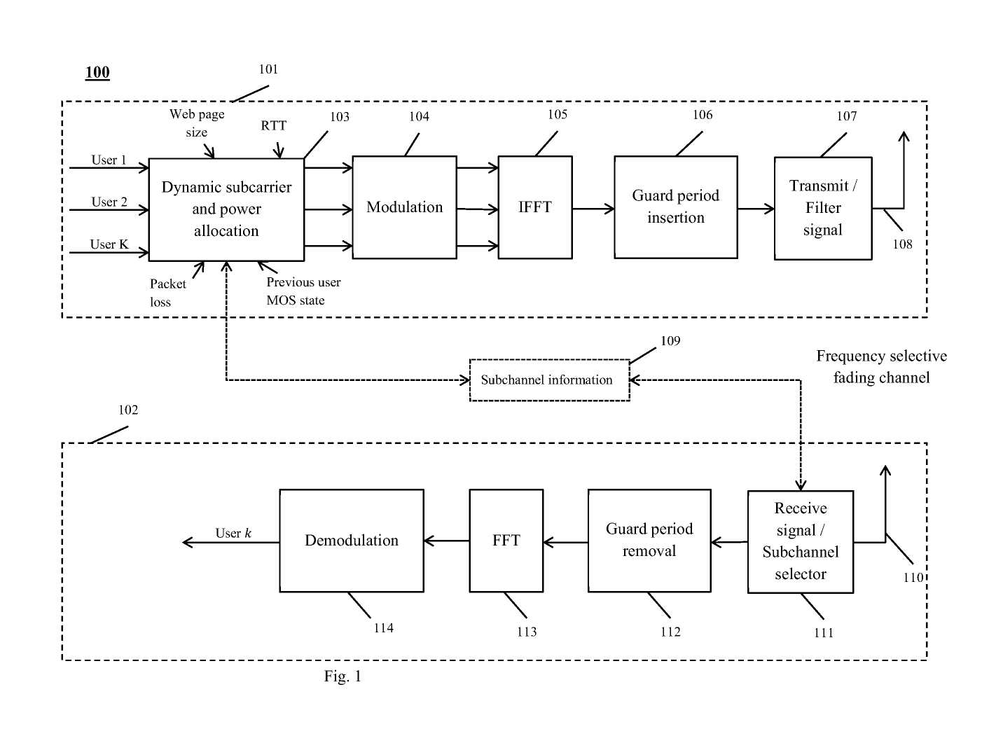

FIG. 1 shows a block diagram of the multiuser OFDM system. The system 100 generally includes a transmit unit 101, incorporated in a base station, and a receive unit 102 (not described in details). Transmit unit 101 consists of a dynamic subcarrier and a power allocation module 103, a modulation module 104, an inverse fast Fourier transform (IFFT) module 105, a guard period insertion module 106, a module 107 for signal transmission and filtering, and a transmit antenna 108.

The module 103 requires for providing QoS at application level the relevant information of the system and users' application parameters, the information of instantaneous channel gain on each subcarrier and information of previous users' MOS states. In case of interactive applications, the web page size, delay and round trip time are appropriate technical parameters, while packet loss, delay and jitter are relevant parameters in case of audio and video applications. The modulation module 104 applies the corresponding modulation schemes (e.g. BPSK, QPSK, QAM) on the symbols. Further, the IFFT module 105 transforms the output complex symbols of the modulation module 104 into the time domain samples by using IFFT. The guard period insertion module 106 inserts a guard period to the end of each OFDM time domain symbol.

This disclosure assumes the multiuser OFDM system with K users and N subcarriers. The disclosure also assumes that the bandwidth of each subcarrier is sufficiently smaller than the coherence bandwidth of the channel. Based on those assumptions, the method provides appropriate QoS at application level and optimizes the throughput of the OFDM system.

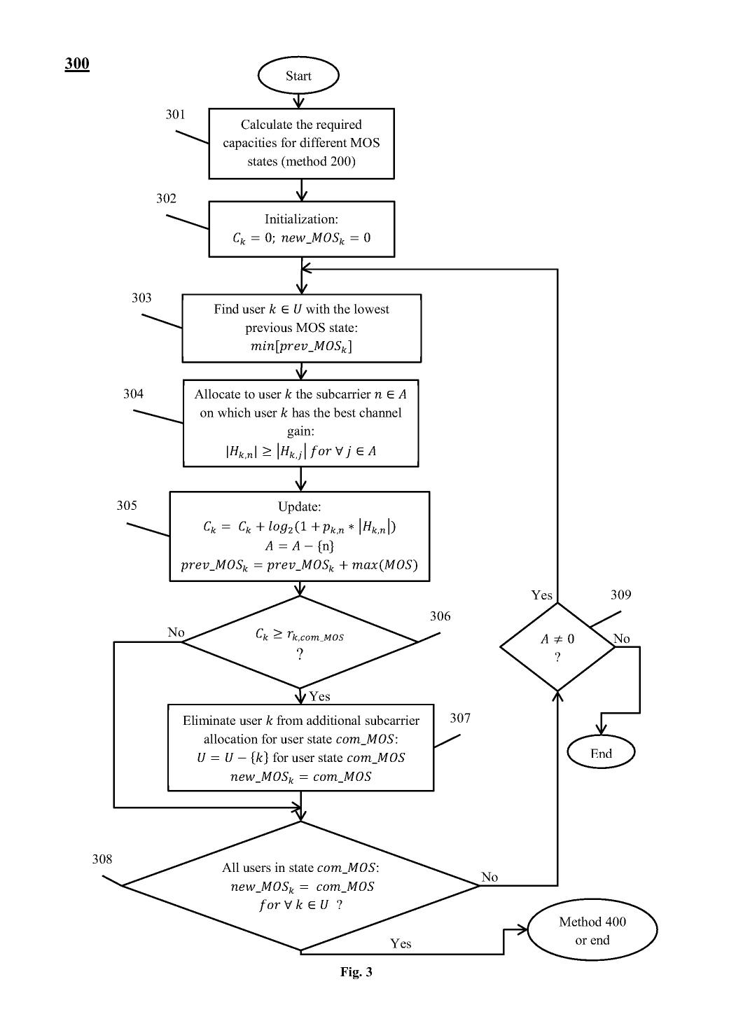

According to the module 103, the method 300 (FIG. 3) dynamically allocates subcarriers to users of the multiuser OFDM system to achieve a common subjective user state (e.g. state MOS=3).

The method 300 dynamically allocates subcarriers to users to achieve a common subjective user state com_MOS. In case of using five point MOS scale, it may be preferable to use state MOS=3 for the common subjective user state, although any MOS value can be used. One embodiment may be illustrated with the MOS function for web browsing which maps the objective technical parameters and the subjective user states. The presented MOS function serves as an example for web browsing, although other more complex MOS functions can be used, which include characteristics of video and audio applications and connect subjective user states with the objective technical parameters:

MOS=4.109*e^{-0.1522*d(r)}+1.05

where function d(r) represents delay. The delay is defined as latency between the time a request for a web page was sent (i.e. HTTP request message) and the time of reception of the entire web page contents. Function d(r) can be described with the following equation:

$$d ( r ) = 4 RTT + \frac{FS}{r} + C \frac{MTU}{r} - \frac{2 MTU ( {2}^{L} - 1 )}{r}$$

where variable r [bit/s] represents bit rate, RTT [s] the round trip time, FS [bit] the web page size, C the constant and MTU [bit] the maximum transmit unit. In case of web browsing, the transmit unit can acquire the information of the web page size through the web proxy server which is usually placed in the operator's environment. The web page size can be obtained from the “HTTP response” message send by the web server, or calculated by using various prediction methods. It is important to note that the value of the delay function depends on the network level parameters such as bit rate, round trip time and application level parameters like the web page size. This means that the value of the delay function adapts to the individual user based on user's application requirements. The method 300 (FIG. 3) allocates subcarriers by selecting user kεU, where U={1, 2, . . . , K), with the minimum previous user MOS state prev_MOSₖ and assigns to the selected user k the subcarrier nεA, where A={1, 2, . . . , N}, on which user k has the best channel gain until user k achieves the common MOS state com_MOS. The method 300 provides explicit control of system resources, incorporates fairness into the system and assures appropriate QoS at application level for each user. In case of connecting a new user to the system, a random initial MOS value can be determined as the previous user MOS state. The proposed initial value for a new user in case of using five point MOS scale is MOS=3.

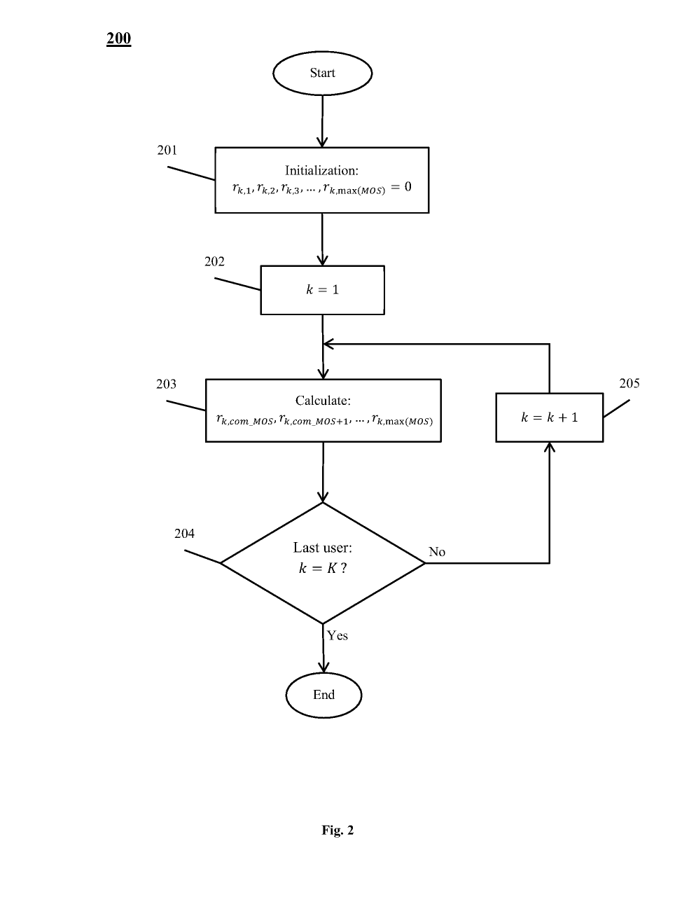

The method 300 starts with the step 301, which calculates the required capacities r_{k,1},r_{k,2},r_{k,3}, . . . , r_{k,max(MOS)}. These values represent user's required capacities to achieve different MOS states. Step 301 is presented in more detail in FIG. 2 as the method 200. The method 200 in step 201 initializes for each user specific variables that represent user's required capacities to obtain specific MOS states according to user's application parameters. In case of defining the common MOS state as com_MOS=3, the method needs to calculate the user's required capacity r_{k,com}_{_{—}}_{MOS} to achieve the common MOS state and capacities r_{k,com}_{_{—}}_{MOS+1}, . . . , r_{k,max(MOS)} for all higher MOS states (step 203). The required capacities can be calculated from the MOS function, which maps the subjective user states and the objective technical parameters of the system and applications. The advantage of using the MOS function in case of web browsing application is dependence of the MOS function on the system and application parameters, such as delay. Furthermore, the delay depends on the web page size, bit rate and round trip time. Calculating the user's required capacity to achieve a certain delay and consequently specific MOS state allows explicit control of system resources in the OFDM system according to user's application requirements.

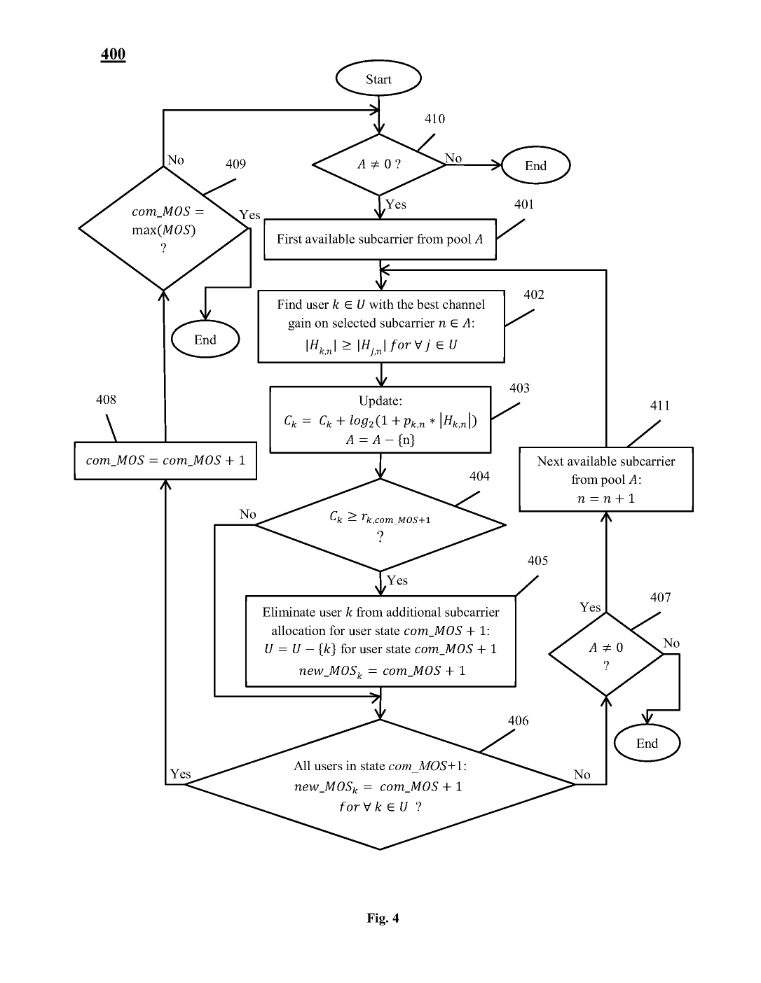

The method 300 continues with the initialization of variable Cₖ and new_MOSₖ (step 302). The variable Cₖ represents allocated capacity to user k, while the variable new_MOSₖ represents the new user MOS state. After the initialization, the method 300 finds user kεU with the lowest previous user MOS state min[prev_MOSₖ] (step 303). Step 304 assigns to selected user k the subcarrier nεA on which user k has the best channel gain. Step 304 solves the following system of equations:

|H_{k,n}|≧|H_{k,j}| for ∀jεA

where H_{k,n} represents channel gain of user k on subcarrier n. Step 305 updates variable Cₖ for user k (variable p_{k,n} in FIG. 3 represents assigned power of user k on subcarrier n, where power can be equally distributed among users) and removes the assigned subcarrier n from the pool of available subcarriers A. Step 305 also changes the initial value of the variable prev_MOSₖ, which represents the previous user MOS states, as follows. For the selected user k, the variable prev_MOSₖ increases for the maximum MOS value of the system. Changing the value of the variable prev_MOSₖ for user k allows choosing in the next iteration of the method 300 a new user that has equal or higher previous user MOS state than the current selected user k. Increasing the previous user MOS state and consequently choosing a new user in each iteration of the method ensures fairness into the resource allocation. Step 306 verifies if the assigned capacity is higher than the required capacity r_{k,com}_{_{—}}_{MOS} of user k to achieve common MOS state. If the condition is not met, the method 300 continues with the step 308. If the condition is met, the step 307 is performed, which eliminates selected user k from additional subcarrier allocation for user state com_MOS. Step 308 verifies if all users of the system achieve common MOS state. If the condition is met, the method 300 ends and the method 400 is performed (FIG. 4).

The method 400 as shown in FIG. 4 optimizes the throughput of the OFDM system and increases QoS at application level by using advanced dynamic subcarrier allocation.

The method 300 (FIG. 3) can continue with the method 400 if all users achieve in method 300 the defined common MOS state corn MOS. The essence of the method 400 is optimizing the throughput of the OFDM system while increasing user's QoS; that is achieving higher user's MOS state than the defined common MOS state. The throughput of the system is optimized in step 402 which finds user kεU with the best channel gain on selected available subcarrier n EA. Step 402 solves the following system of equations:

|H_{k,n}|≧|H_{j,n}| for ∀jεU

Step 403 updates the capacity Cₖ for user k and removes the assigned subcarrier n from the pool of available subcarriers A. Step 404 verifies if the capacity Cₖ of user k is higher than the user's required capacity r_{k,com}_{_{—}}_{MOS+1} for MOS state com_MOS+1, which represents one higher MOS state than the defined common MOS state. If the condition in step 404 is met, the step 405 is performed, which eliminates user k from the further subcarrier allocation for MOS state com_MOS+1. Step 406 verifies if all users achieve MOS state com_MOS+1. If the condition is met, the method 400 repeats from the beginning. Step 408 changes the value of the defined common MOS state com_MOS. The variable is increased in one higher MOS state than the current common MOS state. If the condition in step 406 is not met, the method 400 repeats with the allocation of the next available subcarrier. The method 400 ends when all users achieve the maximum MOS state (step 409), or when A=0. The variable new_MOSₖ represents the new user MOS state and is used as the previous user MOS state in the next iteration of the method 300 or method 400.

While the foregoing written description enables one of ordinary skill to make and use what is considered presently to be the best mode thereof, those of ordinary skill will understand and appreciate the existence of variations, combinations, and equivalents of the specific exemplary embodiments and methods herein. The invention should therefore not be limited by the above described embodiments and methods, but by all embodiments and methods within the scope and spirit of the invention as claimed.

What is claimed is:

1. A method for providing quality of service (QoS) in a multiuser orthogonal frequency division multiplex (OFDM) system using advanced dynamic subcarrier allocation to achieve a common subjective user state, comprising:
a) calculating the user's required capacities for different subjective user states;
b) finding the user with the lowest previous subjective user state;
c) allocating the subcarrier to the user with the lowest previous user state;
d) updating the user's assigned capacity, the number of available subcarriers and the previous subjective user state;
e) verifying the user's assigned capacity;
f) eliminating the user from additional subcarrier allocation for the common subjective user state;
g) continuing the method with the method that optimizes the throughput of the system and increases the quality of service at application level.

2. A method of claim 1, wherein the step of calculating the user's required capacities for different subjective user states calculates the capacities for the common subjective user state and all higher subjective states than the common subjective state for each user of the system.

3. A method of claim 2, wherein the user's required capacities are calculated from the function that maps the subjective user states and the objective technical parameters of the system, such as delay, jitter, packet loss and application parameters, like the web page size or similar.

4. A method of claim 1, wherein the step of allocating the subcarrier to the user with the lowest previous user state assigns to the selected user the subcarrier from the pool of available subcarriers on which user has the best channel gain.

5. A method of claim 1, wherein the step of updating the number of available subcarriers and previous subjective user state removes the assigned subcarrier from the pool of available subcarriers and increases the previous subjective user state for the maximum subjective state of the system.

6. A method of claim 1, wherein the step of verifying the user's assigned capacity compares the assigned capacity with the user's required capacity to achieve the common subjective user state.

7. A method of claim 1, wherein the step of eliminating the user from additional subcarrier allocation for the common subjective user state removes the user if user's assigned capacity is equal or higher than the user's required capacity to achieve the common subjective user state.

8. A method of claim 1, wherein the step of continuing the method with the method that optimizes the throughput of the system is performed if all users of the system achieve the common subjective user state.

9. A method of claim 1, where the new subjective user state, calculated in the previous iteration of the method, is used as the previous subjective user state when the method starts from the beginning.

10. A method of claim 1, where in case of connecting a new user to the system, any initial subjective value is determined as the previous subjective user state for a new user.

11. A method of claim 1, where each subcarrier is assigned to only one user.

12. A method for providing quality of service (QoS) in a multiuser orthogonal frequency division multiplex (OFDM) system using advanced dynamic subcarrier allocation to optimize the throughput of the system while increasing the quality of service at application level, comprising:
a) choosing the subcarrier from the pool of available subcarriers;
b) allocating the subcarrier to the appropriate user;
c) updating the user's assigned capacity and the number of available subcarriers;
d) eliminating the user from the additional subcarrier allocation for a certain subjective state;
e) repeating the method that optimizes the throughput of the system.

13. A method of claim 12, wherein the step of allocating the subcarrier assigns the available subcarrier to the user from the set of non-excluded users for a certain subjective state with the best channel gain on available subcarrier.

14. A method of claim 12, wherein the step of updating the number of available subcarriers removes the assigned subcarrier from the pool of available subcarriers.

15. A method of claim 12, wherein the step of eliminating the user from additional subcarrier allocation for a certain subjective user state removes the user if user's assigned capacity is equal or higher than the user's required capacity to achieve a certain subjective user state.

16. A method of claim 15, wherein a certain subjective user state is one higher subjective state than the specified common subjective user state.

17. A method of claim 12, wherein the step of repeating the method that optimizes the throughput of the system is performed by allocating the next available subcarrier.

18. A method of claim 12, wherein the step of repeating the method that optimizes the throughput of the system is performed from the beginning.

19. A method of claim 17, where the method is performed by allocating the next available subcarrier if all users do not achieve one higher subjective state than the specified common subjective user state.

20. A method of claim 18, where the method is performed from the beginning if all users achieve one higher subjective state than the specified common subjective user state.

21. A method of claim 18, where the common subjective user state increases to one higher subjective state before the beginning of the method.

22. A method of claim 12, where each subcarrier is assigned to only one user.

23. A method for providing quality of service (QoS) in a multiuser orthogonal frequency division multiplex (OFDM) system using advanced dynamic subcarrier allocation to achieve a common subjective user state and/or optimize the throughput of the system while increasing the quality of service at application level.

24. A method of claim 23, wherein the method that uses dynamic subcarrier allocation to achieve a common subjective user state continues with the method that optimizes the throughput of the system while increasing the quality of service at application level.

25. A method of claim 24, wherein the method that optimizes the throughput of the system while increasing the quality of service at application level is performed if all users of the system achieve the common subjective user state.
